(19) United States
(12) Patent Application Publication
(10) Pub. No.: US 2015/0073730 A1
(43) Pub. Date: Mar. 12, 2015

(54) MECHANICAL STRAIN GAUGE SIMULATION

(71) Applicant: AIRBUS OPERATIONS S.A.S., Toulouse (FR)

(72) Inventors: Paolo MESSINA, Toulouse (FR); Florian DUBEAUREPAIRE, Colomiers (FR); Stephane LE DROGO, Toulouse (FR)

(21) Appl. No.: 14/478,223

(22) Filed: Sep. 5, 2014

(30) Foreign Application Priority Data
Sep. 6, 2013 (EP) 13306224.0

(51) Int. Cl. G01M 17/00; G06F 17/50; G01N 3/00

(52) U.S. Cl. CPC G01M 17/00; G01N 3/00; G06F 17/5095
USPC 702/42

(57) ABSTRACT

A method for the computerized simulation of mechanical deformation is provided. The method makes it possible to define a strain gauge in a model of a mechanical structure in order to calculate the deformation at said gauge. The method makes it possible to simulate at will the measurement result of a strain gauge in a mechanical structure model.

### CROSS-REFERENCE TO RELATED APPLICATION

This application claims priority to European Patent Application No. 13 306 224.0 filed Sep. 6, 2013, which is incorporated herein by reference in its entirety.

### TECHNICAL FIELD

The technical field relates to the field of the development of mechanical structures. During such developments, measurements of mechanical strength are taken. In particular, this type of measurement can be carried out during the phase of certification of the mechanical structure in order to ensure that the mechanical structure complies with strength requirements set by standards or a schedule of specifications.

### BACKGROUND

In the aeronautical field, mechanical strength measurements are commonplace. Before an aircraft is flight tested, checks are carried out to ensure that the mechanical structure of the aircraft is capable of withstanding the stresses to which it will be subjected in flight.

In the development of mechanical structures (those of aircraft for example), there is a need to detect any undesirable mechanical behaviour as early as possible in order to avoid delay to the development program, together with its cost implications.

A strength measurement procedure takes place in two phases.

In a first phase, the mechanical structure under investigation is modelled and a computerized simulation of a mechanical deformation of the structure is carried out. This simulation may take account of the presence, on the mechanical structure, of elements for the physical measurement of mechanical deformation, typically “strain gauges”.

In a second phase, an actual test is performed on the mechanical structure by imparting the simulated mechanical stress. The strain gauges make it possible to collect actual measurements.

Generally, the strain gauges are placed at locations chosen for the investigation and analysis of critical areas of the mechanical structure where the imposed mechanical deformations may weaken it.

Thus, once the simulation and the actual test have been carried out, the results respectively originating from these phases are compared in order to check whether or not the actual test has taken place in accordance with the simulation predictions. More specifically, the results provided by the strain gauges during the actual test are compared with the results of the simulation, at the same positions in the model.

In order to obtain accurate and complete strength measurements, it is advisable to perform mechanical deformation measurements at numerous positions in the mechanical structure. It is then also necessary to launch accurate simulations in the modelling of the mechanical structure so as to have the same number of points of comparison as with the actual test.

The use of the simulation can then pose problems of implementation.

In fact, the more accurate the model of the mechanical structure is, the more complex the simulation calculations are. They therefore require a high processing power and a large memory capacity (in order to store the model, the processing data and the processing results). The processing times are therefore lengthy.

For example, in order to simulate a mechanical structure of an aircraft, the simulation time is of the order of several days.

When a simulation is launched, it is therefore necessary to have confidence in the model used for modelling the mechanical structure. It is also necessary to have confidence in the position chosen for the strain gauges.

It is possible that the positioning of strain gauges may be defined late in the procedure. In order to maintain the objective of accuracy, it is then necessary to redefine the simulation model in order to include the late positioning(s). However, this delays the strength measurements and the development program. In certain cases, where a simulation has for example already been launched, addition or modification of the positioning of strain gauges may be abandoned.

The complete modelling of a strain gauge, within the mechanical structure model itself offers a high level of accuracy of the simulation results.

However, when the characteristics of the strain gauge change, or its positioning in the mechanical structure changes, the entire simulation must be relaunched, optionally on a new modified model.

An alternative can consist of performing mechanical deformation calculations within the simulated model itself.

This alternative makes it possible, once the simulation results have been obtained, to access knowledge of the mechanical deformations over the entire structure.

However, for this knowledge to be complete and not require the launch of fresh simulations, it is necessary for the mechanical deformation calculations to be carried out at numerous points. The necessary processing power then becomes too great for large mechanical structures. Moreover, the storage of the simulation and processing results becomes problematic, since the volume of data also becomes large.

According to other alternatives, the mechanical deformations can be performed based on the movement of the points of the model of the simulated mechanical structure.

This alternative makes it possible to avoid relaunching the simulation when new strain gauges are defined (or their position changed) for the actual test.

However, in order to be able to perform these calculations, it is necessary to produce a very fine grid in the mechanical model for the calculation to be meaningful. In fact, the dimensions of a strain gauge can be of the order of 3 to 6 mm, while the dimensions of an element of a simulation model are of the order of several centimetres. The complexity of calculation is therefore increased.

Moreover, calculations of bending cannot be taken into account.

In addition, other objects, desirable features and characteristics will become apparent from the subsequent summary and detailed description, and the appended claims, taken in conjunction with the accompanying drawings and this background.

### SUMMARY

Accordingly, a need exists for improving computer implemented mechanical deformation simulation techniques, in particular in the case of mechanical structures of large dimensions such as those of aircraft.

One of various aspects of the present disclosure relates to a computer implemented method for the simulation of mechanical deformation on a mechanical structure, in which: said mechanical structure is defined according to a model comprising a grid of said structure with grid nodes defining grid elements, and a result of the simulation of mechanical deformation of said structure is obtained, said result comprising said model of said structure, deformed by said simulation of mechanical deformation.

In one example, the method comprises the following: defining at least one simulated strain gauge between a first starting position and a second starting position with respect to said model. For each starting position, the method comprises: selecting a grid element of said model, projecting each said starting position onto said selected grid element, determining, based on said mechanical deformation simulation result, a position of the projection of each said starting position onto said deformed grid element and at said position of said projection, applying an inverse transform to said projection in order to obtain an arrival position.

The method also comprises: calculating a first distance between said first and second starting positions, calculating a second distance between a first arrival position obtained for the first starting position and a second arrival position obtained for the second starting position, and calculating a deformation associated with said simulated strain gauge, based on said first and second distances.

The method according to this example allows the optimum simulation of strain gauges in a mechanical structure. These simulated strain gauges are referred to below as strain gauges.

The calculations necessary for such a simulation are simplified. Moreover, the amount of memory necessary for such a simulation is reduced.

This method allows the use of simulations in the event of late definition of the actual strain gauges, without delaying the development program. It is not necessary to modify the model and to relaunch a full simulation once again when new actual strain gauges are defined.

This method allows the simulation of complex mechanical structures and the simulation of strain gauges in such structures. This method also makes it possible for example to simulate the complete structure of an aircraft and to extract therefrom and examine mechanical deformation information.

The use of this method falls within the industrial procedure for the development of mechanical structures, in particular mechanical structures of large dimensions (such as for example aircraft). Such mechanical structures can require the use of a large number of actual strain gauges, sometimes up to several tens of thousands. It is then necessary to simulate the same number of simulated strain gauges.

The use of this method allows development time to be saved by reducing the simulation time necessary. In particular it offers great flexibility since the strain gauges can be defined and redefined at will without the need to relaunch complex simulations.

The method described above is implemented by a computer means. It is used for the specific technical application of the simulation of strain gauges. It can be used for the purpose of a comparison with measurement results from actual strain gauges used in an actual test of the mechanical structure modelled.

This method can comprise defining the model of the mechanical structure. It can moreover comprise simulating the mechanical deformation of the model.

According to embodiments, said selected grid element is the grid element of said model closest to each said starting position. For example, said selection of said grid element comprises the following: determining a node of the model closest to each said starting position, determining a set of grid elements connected to said closest node, and selecting, from said set of grid elements, a grid element closest to each said starting position.

For example, said selection from the set of grid elements comprises the following: calculating, for each grid element of said set, an average distance between each said starting position and the nodes of the model defining each said grid element, and comparing said average distances calculated for each grid element of said set.

The method can moreover comprise the following: defining a first system of coordinates associated with said selected grid element, and defining said position of said projection into said system of coordinates, in which said first system of coordinates is defined by an origin taken at a characteristic point of said selected grid element and two base vectors extending from said origin to two respective nodes defining said selected grid element.

The method can moreover comprise the following: defining a second system of coordinates associated with said deformed selected grid element, said second system of coordinates being defined by an origin and two base vectors corresponding to the origin and to the base vectors of the first system of coordinates, and determining said position of said projection into said second system of coordinates.

For example, the coordinates of said position of said projection into the second system of coordinates are proportional to the coordinates of said position of said projection into the first system of coordinates. Said origin is for example taken at a node defining said selected grid element or a centre of said selected grid element. For example, said inverse transform is determined based on rotations undergone at said selected grid element.

The determination of said inverse transform can comprise the following: selecting a plurality of nodes defining said selected grid element, determining respective rotations undergone by the nodes of said plurality during the mechanical deformation, calculating a rotation at said projection of each said position; and determining said inverse transform, based on said calculated rotation.

For example, the method also comprises the following: determining an axis normal to said deformed selected grid element, at said projection of each said position; applying said calculated rotation to said determined normal axis; and calculating said arrival position on the axis thus obtained.

Said arrival position is for example calculated at a distance from said projection of each said position equal to the distance separating each said position of said projection into the model before deformation.

According to embodiments: for two opposite nodes Nᵢ, Nⱼ of said plurality having respective determined angles of rotation αᵢ, αⱼ, respective relative angles of rotation α_{Ri}, α_{Rj} are calculated as follows:

$${α}_{Ri} = {α}_{i} - \frac{{α}_{i} + {α}_{j}}{2} , \\ {α}_{Rj} = {α}_{j} - \frac{{α}_{i} + {α}_{j}}{2} ,$$

and

in order to calculate said rotation at said projection of each said position, a relative angle of rotation α_{RP} associated with said projection is calculated as follows:

α_{RP}=α×α_{Rk}+b×α_{Rl},

With α_{Rk}, α_{Rl} being the respective relative angles of rotation of two nodes Nₖ, Nₗ of said plurality to which axes X and Y of said second system of coordinates point, and (a,b) being the coordinates of said projection into said second system of coordinates.

According to embodiments, said deformation calculation is carried out based on a rate of change of the distance between the ends of said stress gauge following said deformation. For example, said mechanical structure is that of an aircraft.

One of various aspects of the present disclosure relates to a method for testing a mechanical structure comprising the following: simulating a mechanical deformation according to the method described previously herein; obtaining a measurement result from an actual strain gauge, placed in accordance with said simulated strain gauge on said mechanical structure, said actual strain gauge measuring a mechanical deformation applied to said mechanical structure and corresponding to said simulated deformation; and comparing said measurement result with said calculated deformation.

One of various aspects of the present disclosure relates to a device for the computer implemented simulation of mechanical deformation and/or testing of mechanical structure, configured for the implementation of the method described herein. For example, such a device comprises a processing unit configured for the implementation of the methods described herein.

One of various aspects of the present disclosure relates to a computer program as well as a computer program product and a storage medium for such program and product, allowing the implementation of the methods described herein when the program is loaded and executed by a processor of a device for the computerized simulation of mechanical deformation and/or testing of mechanical structure according to embodiments.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIGS. 1A and 1B show the deformation of a model of a mechanical structure;

FIG. 2 is a flow chart of a general method of implementation according to various embodiments;

FIG. 3 is a block diagram showing a system of implementation according to various embodiments;

FIG. 4 shows the selection of the grid elements of the model onto which the ends of the strain gauges are projected;

FIGS. 5A and 5B show the projection of the end of a strain gauge on a selected grid element;

FIG. 6 shows an element as deformed during the simulation of a mechanical deformation;

FIG. 7 shows the bending of a grid element and the gradient of rotation which may result therefrom;

FIG. 8 shows the determination of an interpolated rotation;

FIG. 9 shows the determination of an inverse transform in order to obtain an arrival position in the deformed model; and

FIG. 10 shows a computerized simulation device according to various embodiments.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

According to various embodiments of the present disclosure, strain gauges are defined in a simulation model of a mechanical structure. For example, this is a model with finite elements.

Each strain gauge is defined by its ends by two starting points A and B in the initial model, i.e. the model before deformation. The present disclosure is not limited to one-dimensional strain gauges. However, in the interests of brevity, the disclosure hereinafter describes such strain gauges. The use of a gauge having several dimensions (for example a strain gauge “rosette”) can be reduced to the case of several one-dimensional gauges.

Then, depending on the movement of these starting points induced by deformation following the simulation of one or more internal (e.g. temperature, pressure or other) and/or external (aerodynamic, engine thrust or other) stresses on the structure, the deformation at the gauge is determined. The ends of the gauge after deformation are situated at arrival points A′ and B′ (respectively).

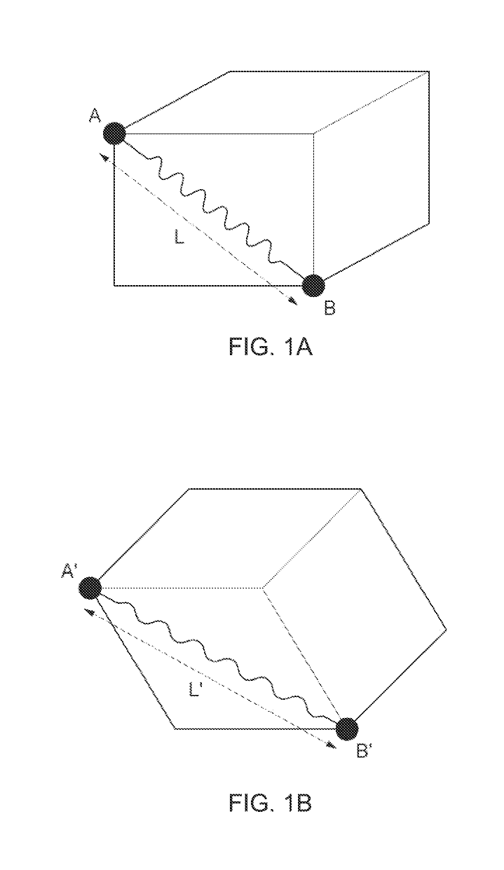

FIGS. 1A and 1B show the deformation of a very simple model of a mechanical structure. This model is a cube. It comprises a plurality of nodes, which in this example are the corners of the cube. These nodes define grid elements, which in this example are the faces of the cube.

It is assumed that in the initial state (FIG. 1A, before deformation), a strain gauge is defined between two corners (or nodes) A and B of the cube. In the initial state, the distance separating these two starting points is L.

In the final state, (FIG. 1B, after deformation), the ends of the strain gauge have moved to arrival points A′ and B′. The distance separating these points is L′. The modelled mechanical structure no longer has the shape of a cube. Under the effect of deformation, the cube has become “flattened”. The deformation at the gauge can be determined by the rate of change of the distance between the ends of the strain gauge (L-L′)/L.

FIGS. 1A and 1B show the simple case where the ends of the strain gauge coincide with nodes of the model. However, the strain gauges must be capable of being placed freely in the mechanical structure, as they will be during the actual test.

A description will be given below of a determination of the movement of the ends of the strain gauge by interpolation of the movement of nodes of the simulated mechanical structure model situated around these ends.

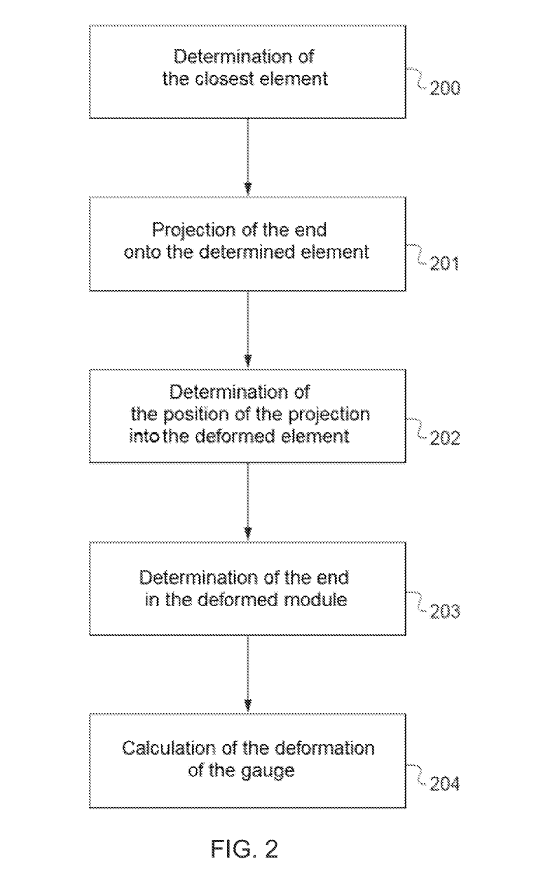

The general method of implementation of various embodiments is summarized in the flow chart in FIG. 2.

Firstly, during 200, for each end of the strain gauge, the closest grid element of the simulation model is determined. This can comprise determining all the grid elements in the vicinity of the end. These grid elements in the vicinity are for example those of which a node forms part of those closest to the end. Then, during 201, the end is projected onto the grid element thus determined. This is for example an orthogonal projection.

The above 200 and 201 are carried out in the initial model, i.e. the model of the mechanical structure, before the mechanical deformation has been simulated.

For the following 202, the simulation results are obtained. The position of the projection of the end into the grid element deformed by the deformation is then determined. As described below, this determination can be done by expression of this position in a reference that is associated with the determined grid element and which deforms with the grid element.

Then, during 203, the position of the end of the gauge in the deformed model is determined, based on the position of the projection thereof. It is possible for this not to be simply performing an inverse orthogonal projection. In order to take account of bending phenomena, as described below, a transform of the projection of the end onto the grid element is determined, based on the rotations of the nodes defining the grid element.

Once each of the positions of the ends of the strain gauge have been determined in the deformed model, the rate of change of its length is determined during 204 in order to deduce therefrom the deformation applied there.

When an actual test on the simulated mechanical structure is implemented, with an actual strain gauge positioned at the same location as that defined in the model, a comparison of the measured deformations and the calculated deformations can be performed.

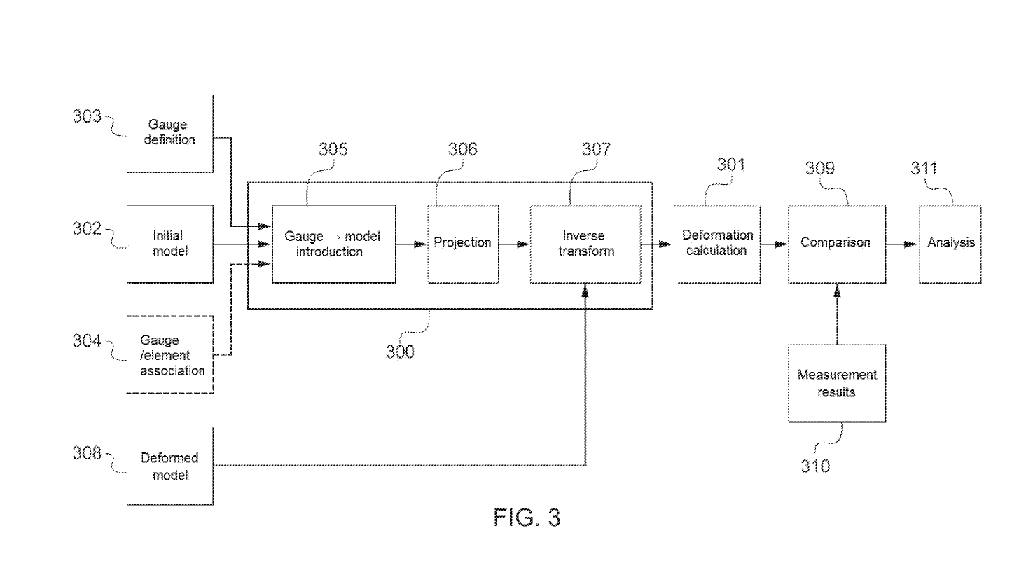

FIG. 3 is a block diagram showing a system for implementing simulation procedures such as those described above.

The system comprises for example a geometrical calculation module 300 and a mechanical deformation calculation module 301 which are detailed hereinafter. Module 300 receives as input a certain number of data items originating from input modules. For example, module 302 is a module for defining the initial model of the mechanical structure to be simulated. For example, module 302 defines a model with finite elements that it provides as input to module 300.

Module 303 makes it possible for example to define one or more strain gauges. For example, a user places the ends of the strain gauges at locations to be monitored during the actual test phase in order to obtain accurate information on the mechanical deformations undergone by the structure at these locations. Defining the mechanical gauges can be done by navigation in the initial model (defined by module 302) or by direct definition (with coordinates).

In order to assist with placing the strain gauges, a module 304 can make it possible to associate a strain gauge with a grid element of the initial model. For example, the grid elements of the initial model are denoted by identifiers and the user can associate a strain gauge with an identifier, which can have the effect of automatically placing the strain gauge on the element denoted. This can be useful, for example for monitoring a group of grid elements representing a specific part of the mechanical structure (for example an aeroplane wing). The elements of the group can be associated with a generic identifier and, by associating a number of strain gauges with this group, the user can initiate a distribution of the strain gauges over the elements of the group. This thus allows the user to define the strain gauges more quickly and more easily.

In one example, the data originating from the input modules can be provided from within module 300 to a module 305 for the introduction of strain gauges into the model. Module 305 makes it possible to place the ends of the strain gauges in the model at the locations defined by modules 303 and/or 304.

Once the gauges have been introduced into the initial model, the model thus enriched is processed by a projection module 306. For each gauge end, module 306 performs the selection of a grid element of the model and the projection of the end onto the selected element.

An inverse transform module 307 makes it possible, based on the deformed model, i.e. originating from the simulation and from the results of module 306, to place the projections of the ends of the strain gauges in the deformed model.

The deformed model originates from a deformed model provision input module 308. This can be for example a simulation module having received as input the initial model and a definition of the mechanical deformation to be simulated.

Once module 307 has determined the position of the ends of the strain gauges in the deformed model, the deformation calculation module 301 determines, based on the comparison of the distance between these ends in the initial model and in the deformed model, the mechanical deformation applied at this strain gauge, according to the simulation.

Once the actual test has been performed, with one or more actual strain gauges placed at the same locations as the ones simulated, it is possible to compare the data originating from the calculations of module 301 with those of the actual strain gauges. This comparison can be carried out by a comparison module receiving as input the deformation calculations of module 301 and the measurement results of the actual strain gauges provided by a measurement results storage module 310. The comparison results can then be provided to an analysis module 311 for correcting and/or improving the mechanical structure or also confirming the one which has been simulated and tested.

The procedure for determining the arrival positions of the ends of the strain gauges in the deformed model is described in greater detail below.

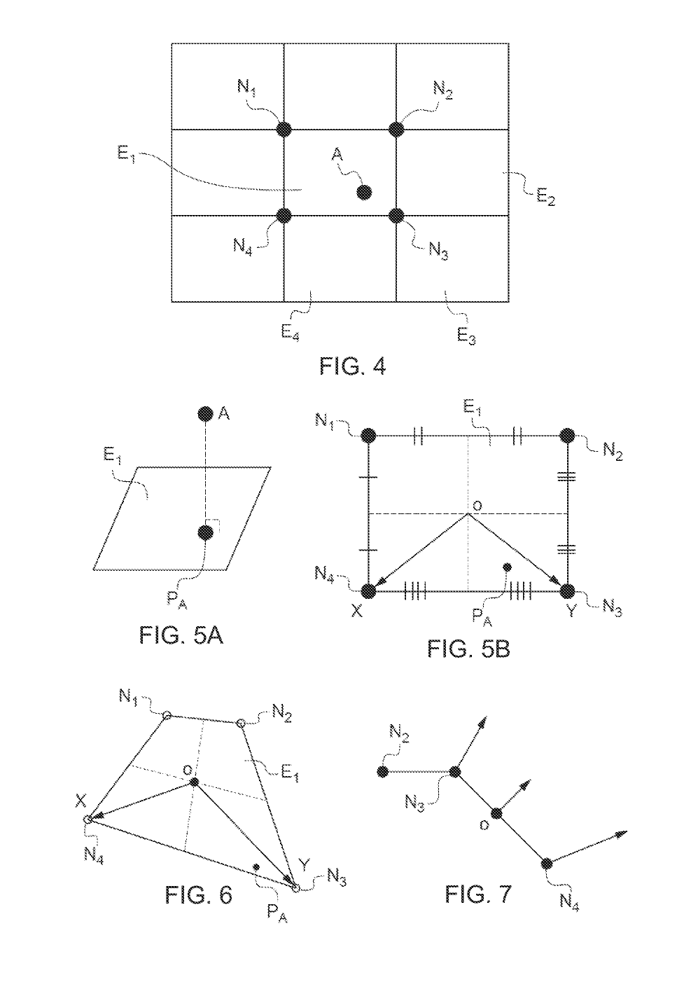

With reference to FIG. 4, the selection of the grid elements of the model onto which are projected the ends of the strain gauges is described.

FIG. 4 shows diagrammatically a portion of a model of a mechanical structure. In the interests of clarity, a simple grid is shown which comprises six grid elements having the shape of a parallelogram (for example a square, a rectangle or other). The grid can be three-dimensional and the grid elements can have different shapes. Point A represents a position of an end of a strain gauge.

Firstly, the node closest to point A is sought. From the plurality of nodes N₁, N₂, N₃, N₄ of the model that are closest to point A, the one at the shortest distance {square root over ((x−x_{A)})²+(y−y_{A)})²+(z−z_{A)})²)} is selected (the triplet (x, y, z) represents the coordinates of the nodes in question and the triplet (x_{A}, y_{A}, z_{A}) those of point A). For example, points N₁, N₂, N₃, N₄ are selected, based on a user identifying the grid element E₁ on which he wishes to position point A.

In the example of FIG. 4, the node closest to point A is node N₃. Secondly, all the grid elements associated with point N₃ are sought, i.e. all the grid elements defined with point N₃. In the example in FIG. 4, these are elements E₁, E₂, E₃ and E₄.

Thirdly, the grid element onto which the projection of point A is made is selected from elements E₁, E₂, E₃ and E₄. For example, for each of the grid elements E₁, E₂, E₃ and E₄, the average distance between point A and the nodes defining these elements is calculated

$$( {\sum }_{{N}_{i} ∈ Element} \frac{D ( {N}_{i} , A )}{n} ,$$

with D(Nᵢ,A) being the distance between point A and a node Nᵢ and n being the number of nodes Nᵢ defining the element). The selected grid element is then that for which the average distance is the shortest. In the example in FIG. 4, this is the element E₁.

With reference to FIGS. 5A and 5B, the projection of the end of a strain gauge onto a selected grid element is described.

FIG. 5A shows the selected grid element E₁ and point A. The projection of point A onto the element makes it possible to obtain point P_{A}. For example, the projection is an orthogonal projection. Once the projection has been obtained, it is expressed in a system of coordinates associated with the grid element E₁. This system of coordinates is illustrated by FIG. 5B.

The origin O of the system of coordinates is chosen such that it is the centre of the grid element. The centre is for example chosen here, in the case of an element in the shape of a quadrilateral such as the intersection of the lines linking the middle of two opposite sides). The axes (X, Y) of the system are chosen so that the coordinates of point P_{A} are positive. Here, the axis X is directed to the node N₄ and the axis Y is directed to the node N₃.

Moreover, the grid elements can be defined with a thickness. The projection can then be done onto the face closest to point A, or onto a fictitious surface between the two faces of the element. Once the projection of point A has been obtained in the system of coordinates associated with the selected grid element, its position in the deformed grid element is determined following the simulation of the mechanical deformation.

FIG. 6 shows the element E₁ as deformed during the simulation of the mechanical deformation on the structure. The defined system of coordinates follows the same deformations. Thus, the origin is found at the centre of the grid element and the axes X and Y are directed to the nodes N₄ and N₃ respectively.

The projection P_{A} of point A is then positioned on the deformed grid element. The position of the projection is defined relative to the deformed system of coordinates. Thus, in an absolute reference that is not changed by the deformation, the projection does not have the same coordinates in the initial element and the deformed element. On the other hand, the projection keeps the same values of coordinates in the systems of coordinates associated respectively with the initial element and the deformed element. For example, if the coordinates of the projection are (1, 1) in the system of coordinates of the initial element, these coordinates are (1, 1) in the system of coordinates of the deformed element. It is noted however that the two coordinates are not defined with respect to the same base vectors since those of the system of coordinates of the initial element have been changed by the deformation to form those of the system of coordinates of the deformed element system. Expressed differently, the projection keeps the same coordinates in proportion to the base vectors of the initial system and with respect to the vectors of the deformed system.

The determination of the position of the projection of point A into the deformed model is described in detail below. In order to determine this position, making an orthogonal projection that is the inverse of the one made to obtain point P_{A} in the initial model may not be sufficient. In fact, as shown in FIG. 7, bending of the grid element can introduce different rotations according to the position in the grid element itself.

FIG. 7 shows a view of the deformed grid element E₁. The element is bent, which introduces a gradient of rotation. For example, the rotation at node N₃ is different from that at point N₄. Thus, in order to determine the rotation at point O for example, according to whether the rotation is taken at one node or another, the result is different.

In order to determine the inverse transform to be applied to the projection of the end A, an interpolated rotation is determined by interpolation of rotations of nodes defining the determined grid element. For example, the interpolated rotation is determined based on rotations of the nodes to which the axes of the system of coordinates associated with the grid element are directed.

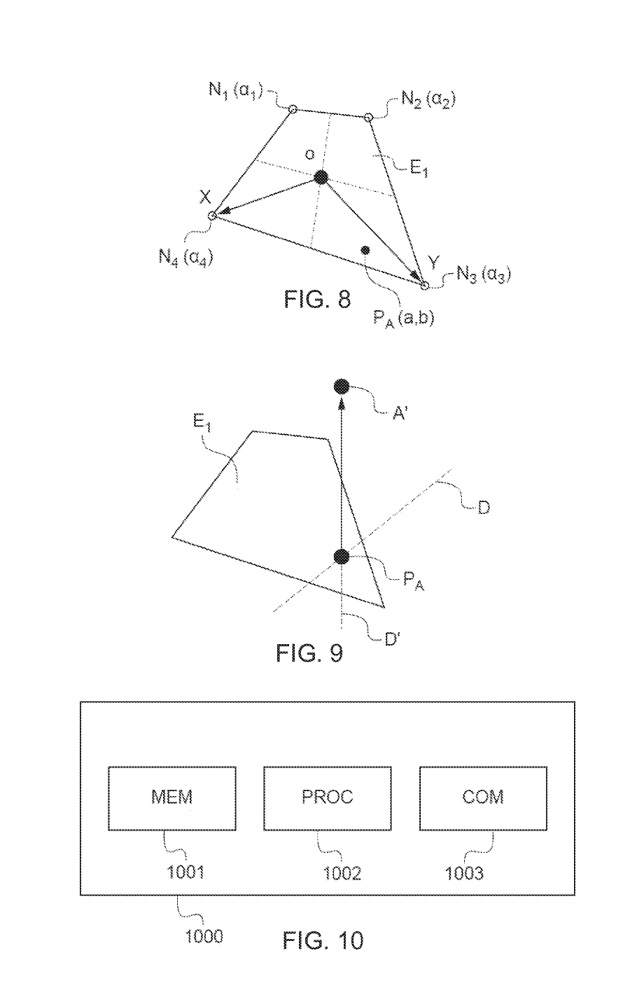

FIG. 8 shows the determination of the interpolated rotation. FIG. 8 shows the deformed grid element onto which the end A of the strain gauge has been projected. Beside each node defining the grid element, the angle of the rotation undergone by the node during the deformation has been shown with respect to an axis of an absolute reference associated with the model of the mechanical structure (reference not shown). In the interests of brevity, only a single axis V of the reference and the angles of rotation with respect to this axis will be considered below. However, in order to give a complete description of the rotations undergone by the nodes, the angles of rotation with respect to the other axes must be considered.

Thus, the nodes N₁, N₂, N₃ and N₄ have respectively undergone a rotation by an angle α₁, α₂, α₃, α₄, with respect to the axis V of the reference. For the purposes of positioning within the local reference associated with the grid element, relative angles of rotation are defined. For example, they are defined such that the angle of rotation undergone by the origin O of the reference with respect to the axis V is zero.

For example, for two opposite nodes Nᵢ, Nⱼ (having respective angles of rotation αᵢ, αⱼ), i.e. situated on each side of the origin, the respective relative angles of rotation α_{Ri}, α_{Rj} are calculated as follows:

$${α}_{Ri} = {α}_{i} - \frac{{α}_{i} + {α}_{j}}{2}$$

$${α}_{Rj} = {α}_{j} - \frac{{α}_{i} + {α}_{j}}{2}$$

Once the relative angles of rotation have been determined, a relative angle of rotation α_{RPA} associated with the projection P_{A} of the end A of the strain gauge is calculated as a sum of the relative angles of rotation of the nodes to which the axes X and Y of the system of coordinates associated with the grid element E₁ point, this sum being weighted by the coordinates (a,b) of this projection into this system of coordinates. Here the axes X and Y point to the nodes N₄ and N₃, the relative angle of rotation is then:

α_{RPA}=α×α_{R4}+b×α_{R3}

This relative angle calculation is performed three times for each axis of the absolute reference associated with the model of the mechanical structure. As already mentioned above, in the interests of brevity, the calculation is given only once for an axis V of the reference.

Once the three relative angles of rotation have been determined, the rotation thus defined with respect to the axes of the absolute reference associated with the model is used to determine the inverse transform which makes it possible to pass from the projection P_{A} to the arrival position A′ of point A in the deformed model.

FIG. 9 shows the determination of the inverse transform for obtaining the arrival position A′ of point A in the deformed model. This figure shows in a simplified manner the deformed grid element E₁. Firstly, the axis D normal to the deformed element and passing through the projection P_{A} of the end A is determined.

Then the previously determined rotation with the relative angles α_{RPA} calculated for each axis of the absolute reference is applied to the axis D. An axis D′ is thus obtained. Point A′ is then obtained by moving point P_{A} on the axis D′. For example, point A′ is placed at the same distance between point A of the initial model (before deformation) and point P_{A}.

When the arrival positions (A′ and B′) have been determined for the two ends (A and B) of the strain gauge, the distances L and L′ between the starting points A and B and the arrival points A′ and B′ are calculated.

The rate of change of the distance between the ends of the strain gauge (L−L′)/L is then calculated, in order to subsequently determine the local mechanical deformation at the strain gauge. Once the mechanical deformation has been determined it can be compared with a mechanical deformation actually measured by an actual strain gauge on the mechanical structure. In the case of divergence, it is possible to detect an anomaly, for example in the design of the mechanical structure, and thus to correct it. In the case of agreement, the mechanical structure can be validated. It is then possible to pass to tests under more real conditions, for example a flight test of an aircraft.

In the case of divergence it is also possible to detect that the positioning of one or more strain gauges was unsatisfactory in the actual mechanical structure or in the model. It is moreover possible to detect a poor cable connection connecting the strain gauge to the data acquisition system. The comparison between the measured and determined deformations can make it possible to detect other types of problems.

Following the detection of an anomaly, it is possible to review either the model of the mechanical structure or the structure itself, depending on the confidence placed in one or the other. A computer program for implementing a method according to an embodiment of the present disclosure can be produced by a person skilled in the art on reading the flow chart in FIG. 2 and the present detailed description.

FIG. 10 shows a computerized simulation device according to embodiments. The device 1000 comprises a memory unit 1001 (MEM). Said memory unit comprises a random-access memory for the non-durable storage of the calculation data used during the implementation of a method according to an embodiment. The memory unit also comprises a non-volatile memory (for example of the EEPROM type) for storing for example a computer program according to an embodiment for its execution by a processor (not shown) of a processing unit 1002 (PROC) of the equipment. The memory can also store other data mentioned above, for example a mechanical structure model, designations of grid elements, the definition of strain gauges or other.

The device also comprises a communication unit 1003 (COM) for implementing communications, for example for receiving mechanical structure modelling data, results of the simulation of mechanical deformation on the structure, definitions of strain gauges. The communications can also be implemented in order to transmit strain gauge simulation results such as for example rates of increase of gauge length or other. In one example, the communication unit can be configured for communication with a database of mechanical deformation modelling and deformation simulation, with a user interface, with a communication or other network.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A method for the computer implemented simulation of mechanical deformation on a mechanical structure, in which the mechanical structure is defined according to a model comprising a grid of the mechanical structure with grid nodes defining grid elements, a result of the simulation of the mechanical deformation of the mechanical structure is obtained, the result comprising a deformed model of the mechanical structure, the deformed model deformed by the simulation of the mechanical deformation, and the method comprises the steps of:
defining at least one simulated strain gauge between a first starting position and a second starting position with respect to the model, and
for each starting position:
selecting a grid element of the model,
projecting each starting position onto a selected grid element,
determining, based on the mechanical deformation simulation result, a position of the projection of each starting position onto the deformed grid element,
at the position of the projection, applying an inverse transform to the projection in order to obtain an arrival position, and
calculating a first distance between the first starting position and the second starting position,
calculating a second distance between a first arrival position obtained for the first starting position and a second arrival position obtained for the second starting position, and
calculating a deformation associated with the at least one simulated strain gauge, based on the first distance and the second distance.

2. The method according to claim 1, wherein the selected grid element is the grid element of the model closest to each starting position.

3. The method according to claim 1, wherein the selection of the grid element comprises following steps:
determining a node of the model closest to each starting position,
determining a set of grid elements connected to the closest node, and
selecting, from the set of grid elements, a grid element closest to each starting position.

4. The method according to claim 3, further comprising:
defining a first system of coordinates associated with the selected grid element, and
defining the position of the projection into the system of coordinates,
wherein the first system of coordinates is defined by an origin taken at a characteristic point of the selected grid element and two base vectors extending from the origin to two respective nodes defining the selected grid element.

5. The method according to claim 4, further comprising:
defining a second system of coordinates associated with the deformed selected grid element, the second system of coordinates being defined by an origin and two base vectors corresponding to the origin and to the base vectors of the first system of coordinates, and
determining the position of the projection into the second system of coordinates.

6. The method according to claim 5, wherein the coordinates of the position of the projection into the second system of coordinates are proportional to the coordinates of the position of the projection into the first system of coordinates.

7. The method according to claim 5, in which the origin is taken at a node defining the selected grid element or a centre of the selected grid element.

8. The method according to claim 7, wherein the inverse transform is determined based on rotations undergone at the selected grid element.

9. The method according to claim 8, wherein the determination of the inverse transform comprises:
selecting a plurality of nodes defining the selected grid element,
determining respective rotations undergone by each of the nodes of the plurality of nodes during the mechanical deformation,
calculating a rotation at the projection of each position; and
determining the inverse transform, based on the calculated rotation.

10. The method according to claim 9, further comprising:
determining an axis normal to the deformed selected grid element, at the projection of each position;
applying the calculated rotation to the determined axis normal to the deformed selected grid element; and
calculating the arrival position based on the application of the calculated rotation.

11. The method according to claim 10, wherein the arrival position is calculated at a distance from the projection of each position equal to the distance separating each position of the projection into the model before the mechanical deformation.

12. The method according to claim 9, wherein:
for two opposite nodes Nᵢ, Nⱼ of the plurality of nodes having respective determined angles of rotation αᵢ, αⱼ, respective relative angles of rotation α_{Ri}, α_{Ri} are calculated as follows:
$${α}_{Ri} = {α}_{i} - \frac{{α}_{i} + {α}_{j}}{2} , \\ {α}_{Rj} = {α}_{j} - \frac{{α}_{i} + {α}_{j}}{2} ,$$

13. The method according to claim 1, wherein the mechanical structure is that of an aircraft.

14. A method for testing a mechanical structure comprising the steps of:
simulating a mechanical deformation on a mechanical structure, the mechanical structure defined according to a model comprising a grid of the mechanical structure with grid nodes defining grid elements and obtaining a result of the simulation of the mechanical deformation of the mechanical structure, the result comprising a deformed model of the mechanical structure, the deformed model deformed by the simulation of the mechanical deformation;
obtaining a measurement result from an actual strain gauge, placed in accordance with the simulated strain gauge on the mechanical structure, the actual strain gauge measuring a mechanical deformation applied to the mechanical structure and corresponding to the simulated deformation; and
comparing the measurement result with the calculated deformation.

15. A computer program product for the computer implemented simulation of at least one of mechanical deformation and testing of a mechanical structure, comprising:
a tangible storage medium readable by a processor and storing instructions for execution by the processor for the implementation of a method comprising:
simulating a mechanical deformation on a mechanical structure, the mechanical structure defined according to a model comprising a grid of the mechanical structure with grid nodes defining grid elements and obtaining a result of the simulation of the mechanical deformation of the mechanical structure, the result comprising a deformed model of the mechanical structure, the deformed model deformed by the simulation of the mechanical deformation;
obtaining a measurement result from an actual strain gauge, placed in accordance with the simulated strain gauge on the mechanical structure, the actual strain gauge measuring a mechanical deformation applied to the mechanical structure and corresponding to the simulated deformation; and
comparing the measurement result with the calculated deformation.

16. The method according to claim 12, wherein:
in order to calculate the rotation at the projection of each position, a relative angle of rotation α_{RP} associated with the projection is calculated as follows:
α_{RP}=α×α_{RK}+b×α_{Rl},
α_{Rk}, α_{Rl} being the respective relative angles of rotation of two nodes Nₖ, Nₗ of the plurality of nodes to which axes X and Y of said second system of coordinates point, and
(a,b) being the coordinates of the projection into the second system of coordinates.

17. The method according to claim 14, wherein the simulation of the mechanical deformation comprises:
defining at least one simulated strain gauge between a first starting position and a second starting position with respect to the model, and
for each starting position:
selecting a grid element of the model,
projecting each starting position onto a selected grid element,
determining, based on the mechanical deformation simulation result, a position of the projection of each starting position onto the deformed grid element, and
at the position of the projection, applying an inverse transform to the projection in order to obtain an arrival position.

18. The method according to claim 17, wherein the selected grid element is the grid element of the model closest to each starting position.

19. The method according to claim 17, wherein the selection of the grid element comprises:
determining a node of the model closest to each starting position,
determining a set of grid elements connected to the closest node, and
selecting, from the set of grid elements, a grid element closest to each starting position.

20. The method according to claim 14, wherein the mechanical structure is that of an aircraft.
